(19) United States
(12) Patent Application Publication
(10) Pub. No.: US 2003/0229541 A1
(43) Pub. Date: Dec. 11, 2003

(54) Methods and systems for reconciliation of discount certificates

(75) Inventors: Steve Randall, Austin, TX (US); Colleen George, Centennial, CO (US); Kenneth Algiene, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/356,368

(22) Filed: Jan. 30, 2003

Related U.S. Application Data
(63) Continuation-in-part of application No. 10/238,044, filed on Sep. 9, 2002.
Application No. 10/238,044 is a continuation-in-part of application No. 10/167,720, filed on Jun. 10, 2002.

(51) Int. Cl. G06F 17/60

(52) U.S. Cl. 705/14

(57) ABSTRACT

A system is provided in which transaction information may be collected at a point-of-sale with a point-of-sale device having multiple capabilities. The transaction information is accumulated by a transaction controller and/or transaction aggregator for transmission to a central host. The central host may receive the transaction information, determine amounts owed from issuers of the discount certificates and to retailers of the discounted items, and coordinate transfer of funds among financial institutions to settle the discounts. The central host may also be configured to perform fraud-probability analyses on the transaction information, using the results of the analysis to pinpoint specific information on the origin of the potential fraud.

### CROSS-REFERENCES TO RELATED APPLICATIONS

This application is a continuation-in-part of U.S. patent application Ser. No. 10/238,044, entitled “REBATE ISSUANCE AND RECONCILIATION SYSTEMS AND METHODS,” filed Sep. 9, 2002 by Kenneth Algiene, which is a continuation-in-part of U.S. patent application Ser. No. 10/167,720, entitled “REBATE ISSUANCE SYSTEM AND METHODS,” filed Jun. 10, 2002 by Kenneth Algiene, the entire disclosures of each of which are herein incorporated by reference for all purposes.

### BACKGROUND OF THE INVENTION

This application is related to discount certificates. More specifically, this application is related to methods and systems for reconciliation of discount certificates.

The use and reconciliation of discount certificates in commerce are subject to a number of inefficiencies. This may be illustrated in the particular case where the discount instruments comprise redemption coupons that a customer may present to a store when purchasing an identified item. Redemption coupons of this type are coded vouchers that specify conditions for receiving a discount and are commonly provided to customers through mass-distribution methods, such as in newspapers or in mailed flyers. Typically, the redemption coupons are used in supermarkets and specify that a discount, of say $0.50, may be applied if the customer purchases the identified product of a specified size, weight, and/or volume prior to a printed expiration date.

Use and reconciliation of the coupons is typically achieved with the following flow. A company that wishes to issue a coupon to induce customers to purchase its products develops the layout for the coupon and provides the artwork to a printer, such as a newspaper or flyer publisher. The customer reviews available coupons in the newspaper, flyer, or other source, and clips those that the correspond to products the customer wishes to purchase or is induced to purchase because of the discount. In some cases, the source may be an internet source in which coupons may be selected and printed by the customer directly. The customer selects the corresponding items when shopping at the supermarket and presents the coupons to the clerk at a checkout terminal. The clerk checks the items and reviews the coupons to determine compliance with the conditions, applying the discounts to the reduce the total amount due. In some instances, the discounts may be read from a bar code printed on each coupon with a bar-code scanner. The coupons are put in a drawer at the checkout where all the coupons handled by that clerk accumulate during his shift.

At the end of the clerk's shift, the accumulated coupons are delivered to an office within the supermarket. At the end of each day, all the coupons collected by the various clerks on their shifts are put in a bag and labeled with the total monetary value of the coupons. The bag is shipped to the supermarket's headquarters, which similarly receives coupons from a variety of its outlets. The coupons received at the headquarters are periodically bundled and shipped to a clearinghouse, which in some instances is located in a different country to take advantage of lower labor costs. At the clearinghouse, the coupons are sorted according to product manufacturer, and a report is generated for each of the manufacturers summarizing the discounts that have been applied by the supermarket to customers on behalf of the manufacturers. An invoice is prepared for each manufacturer, including a handling fee for the supermarket, and presented to the manufacturers for payment.

One disadvantage of this process is the amount of time that it takes for the supermarket to be reimbursed for applying the discount; it is typical for reimbursement to take 30-45 days, or even longer. Another disadvantage is that the potential for errors and for fraud is relatively high. In particular, clerks are usually working under conditions where the total number of items presented for each customer may be several dozen and where there are other customers waiting in line. It is common for the clerk to read each coupon only casually, if at all, and not to confirm specifically that the coupon is being offered before an expiration date and that all conditions, such as the size, weight, volume, and quantity of the product are met. In such instances, the manufacturer may ultimately be providing a discount under circumstances that it did not intend.

In some cases, ignoring the conditions for applying a discount may be performed intentionally by an individual clerk or even pursuant to an informal store policy. For example, a store may honor coupons past their expiry date in order to appease customers and take advantage of the fact that the manufacturer has no precise way of verifying the date on which the coupon was presented. In other cases, fraudulent handling of coupons may be even more egregious. Examples include clerks who accept a stack of completely unrelated coupons as payment for a friend's entire grocery order. In other instances, the supermarket purchases large volumes of coupons at a very low discount rate and submits an invoice to a manufacturer for the full face amount of the coupon without ever having sold the manufacturer's product. Such culpability on the part of supermarkets is estimated to result annually in hundreds of millions of dollars of coupon fraud in the United States alone. This cost is typically passed back onto consumers in the form of higher prices, and such coupon-fraud schemes have been linked by law-enforcement agencies with terrorist funding schemes.

There is, thus, a general need in the art to improve reconciliation of coupons and other discount certificates, including shortening the time period for reconciliation, reducing the volume of paper moved physically as a component of reconciliation processes, and mitigating the possibility of fraud.

### BRIEF SUMMARY OF THE INVENTION

Embodiments of the invention thus provide methods and systems that permit processing of a plurality of discounted transactions. A system is provided in which transaction information may be collected at a point-of-sale with a point-of-sale device having multiple capabilities. The transaction information may be derived by scanning a bar code or other identifier on each item purchased, scanning an identification card of the customer, and scanning discount instruments that may be presented. The transaction information is accumulated by a transaction controller and/or transaction aggregator for transmission to a central host. The central host may comprise a computer configured to receive the transaction information, to determine amounts owed from issuers of the discount certificates and to retailers of the discounted items, and to coordinate transfer of funds among financial institutions to settle the discounts. The central host may also be configured to perform fraud-probability analyses on the transaction information, using the results of the analysis to pinpoint specific information on the origin of the potential fraud. A data store may house accumulated transaction information, providing the capability of issuing queries to the data store to recover specific information on the distribution of use of the discount instruments. In some instances, electronic versions of the discount instruments may be accommodated. In other instances, even automatic discounts may be applied on the basis of such information as demographic characteristics of the customers.

Thus, in one set of embodiments, a method is provided for processing a plurality of discounted transactions. Transaction information is received at a host computer for each of the plurality of discounted instruments. The transaction information identifies a discount amount applied to a sale of an item by a retailer on behalf of an issuer of a corresponding discount. An amount due from each issuer in accordance with the transaction information is determined, as is an amount due to each retailer in accordance with the transaction information. Requests are transmitted to one or more financial institutions to transfer funds in accordance with the determined amounts due from each issuer and to each retailer. The discount amount may be defined by a discount certificate. In one embodiment, the discount certificate comprises a coupon while, in another embodiment, it comprises an electronic record of terms for application of the discount amount to purchase of the item. The amount due from each issuer may comprise an added handling fee for each corresponding discounted transaction.

There are a variety of ways in which the transaction information may be received at the host computer. In one embodiment, transaction information is received for a plurality of the discounted transactions from a transaction aggregator in communication with a plurality of retailer outlets. In another embodiment, transaction information is received for a plurality of the discounted transactions directly from a plurality of retailer outlets.

The transaction information may be analyzed, such as to identify potential fraud. For example, in one embodiment the transaction information is analyzed to ensure that an expiration date of the corresponding discount is later than a date the discount amount is applied. In another embodiment, the transaction information is analyzed to ensure that the item corresponds to an item specified by terms of the corresponding discount. In some instances, an error tolerance filter may be applied when the transaction is analyzed. When potential fraud is detected, the host computer may respond in different ways. In one embodiment, funds associated with the potential fraud are deposited into an escrow account. In another embodiment, requests are transmitted to the one or more financial institutions to reverse the funds transfer with respect to funds associated with the potential fraud.

The host system may also perform additional functions in some embodiments. For example, in one embodiment, reports may be issued to the retailer and issuer regarding the transfer of funds. In another embodiment, the transaction information may be stored in a queriable data store.

In another set of embodiments, a method is also provided for processing a plurality of discounted transactions. Transaction information for each of the plurality of discounted transactions is received at a transmission controller. The transaction information identifies terms for application of a discount amount. A determination is made with the transmission controller whether the terms have been met. If so, the transaction information is transmitted to a host computer. As for other embodiments, the discount amount may be defined by a discount amount, which may comprise, for example, a coupon or an electronic record of terms for application of the discount amount to purchase of the item. In addition, the method may further comprise analyzing the transaction information to ensure compliance with the terms. Such analysis may be performed in a variety of ways. For example, the transaction information may be analyzed to ensure that an expiration date specified by the terms is later than a date the discount amount is applied. If the transaction information identifies the items purchased, it may be analyzed to ensure that at least one of the items purchased corresponds to an item specified by the terms. If the transaction information identifies demographic characteristics of a purchaser of the items, it may be analyzed to ensure that the demographic characteristics of the purchaser are consistent with qualifying demographic criteria specified by the terms.

In a further set of embodiments, a method provides an electronic discount instrument. An electronic customer interface is provided to present a plurality of possible discount-term selections, each such selection specifying at least an item and discount amount. A customer identifier for a customer is received through the interface. An identification of at least one selected discount-term selection is received from the customer through the interface. The customer identifier and the at least one selected discount-term selection are transmitted to a transmission controller.

The resulting electronic discount instrument may be used by receiving transaction information for purchase of the item corresponding to the at least one selected discount-term selection by the customer from a point-of-sale device. Instructions may then be transmitted to the point-of-sale device to apply the discount amount to the purchase of the item corresponding to the at least one selected discount-term selection. In addition, the transaction information may be transmitted to a host computer for settlement. Also, the transaction information may be analyzed to ensure compliance with terms of the at least one selected discount-term selection. In some instances, the transmission controller and the point-of-sale device are located at the same retailer outlet.

In an additional set of embodiments, a method provides an automatic transaction discount. Qualifying demographic criteria and an item identification for application of a discount amount are received. In addition, transaction information for purchase of the item from a point-of-sale device is received. Customer identification information is received for the purchase of the item. Demographic information is accessed for a customer with the demographic information, and instructions are transmitted to the point-of-sale device to apply the discount amount if the demographic information for the customer is consistent with the qualifying demographic criteria.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a schematic diagram illustrating an infrastructure within which embodiments of the invention may be used;

FIG. 2A is a schematic diagram illustrating a structure of a retailer outlet suitable for interaction within the infrastructure of FIG. 1;

FIG. 2B is a schematic diagram illustrating a structure of a point-of-sale device used at the retailer outlet shown in FIG. 2A;

FIGS. 2C-2E are schematic diagrams illustrating the flow of information to and from the point-of-sale device of according to different embodiments;

FIG. 3 is a schematic diagram illustrating a modular structure of a central host suitable for interaction within the infrastructure of FIG. 1;

FIG. 4 is a schematic diagram illustrating a physical structure of a computer system on which methods of the invention may be embodied;

FIG. 5A is a flow diagram illustrating a method for executing a transaction using a discount certificate in an embodiment;

FIG. 5B is a flow diagram illustrating a method for executing a transaction using a discount certificate in another embodiment;

FIG. 5C is a flow diagram illustrating a method for executing a transaction using a discount certificate in a further embodiment;

FIG. 6A is a flow diagram illustrating a method for reconciling discounts applied according to multiple discount certificates in an embodiment; and

FIG. 6B is a flow diagram illustrating a method for detecting fraud in connecting with applying discounts to multiple discount certificates in an embodiment.

### DETAILED DESCRIPTION OF THE INVENTION

The following provides a description of embodiments of the invention that pertain to discount certificates. As used herein, the term “discount certificate” is intended to be construed broadly as referring to any document that provides a financial benefit to a consumer in connection with a consumer transaction. In some instances, the discount certificate may be associated with a particular good or service, such as in the case of a redemption coupon used to reduce the cost of the specified good or service at the time the good or service is purchased. In other instances, the discount certificate may apply generally a transaction, irrespective of the subject of the transaction, such as where a 10% reduction is applied to all merchandise purchased on a particular date from a particular retailer. In some instances, the discount certificate may correspond to a rebate that is provided some time after the associated transaction is executed. The invention is also not limited by the physical form of the discount certificate. For example, the certificate could be a paper certificate, such as in the case of a redemption coupon, but could alternatively take the form of a printing on any suitable object, such as a bottle cap or other product. The certificate may also take the form of an electronic certificate, which has the discount conditions specified in an electronic file. Also, while many discount certificates may include additional conditions, such as time limits, product sizes, quantities, and the like, this is not a requirement; a document that merely specifies the financial benefit to the consumer without condition is intended to fall within the scope of a “discount certificate.”

The party on whom financial responsibility of the discount certificate ultimately falls is referred to herein as the “issuer” of the discount certificate. In many instances, the issuer may correspond to a manufacturer of a product or provider of a service that terms of the discount certificate require be purchased. In some of the embodiments described below, an intermediary initially provides the financial benefit to the consumer, with the expectation that the intermediary will be reimbursed by the issuer, usually with a handling fee for its role as intermediary. Such an intermediary is generally referred to herein as a “retailer” to emphasize those embodiments in which a product or service defined by the discount certificate is obtained by the customer from the intermediary, but such a relationship is not specifically required. The financial reconciliation of the discount certificate is often carried out through interaction with a financial institution associated with the issuers and/or retailers. Such financial institutions may be any institutions that handle funds on behalf of such parties, including banks, credit unions, and the like.

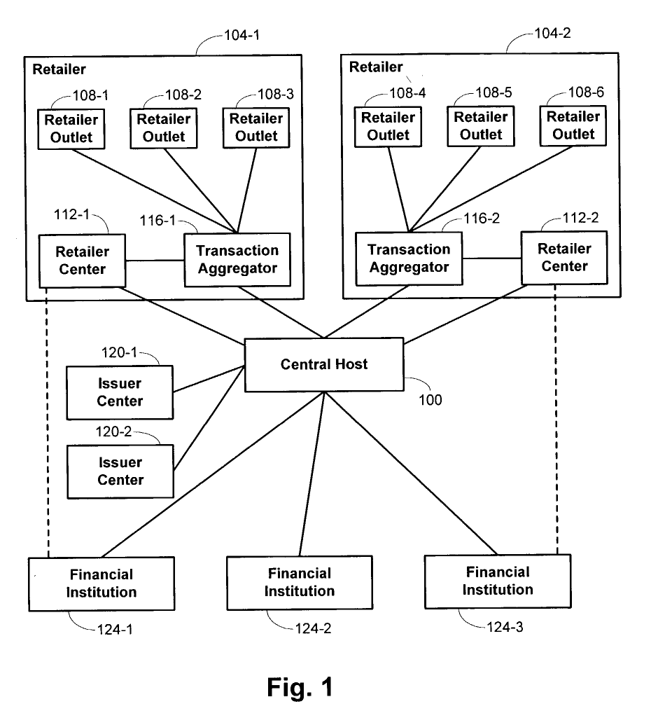

In one embodiment, illustrated schematically in FIG. 1, the issuers, retailers, and financial institutions that may be involved are interconnected with an infrastructure that permits communication with those parties as described below. The reconciliation of the discount certificates may be coordinated with a central host 100, that is provided in communication with each of the retailers 104, issuers 120, and financial institutions 124. Each of a plurality of retailers 104 comprises a retailer center 112 at which administrative functions of the retailer may be coordinated, including overall financial matters. Different retailers 104 may conduct their financial affairs using different financial institutions 124, highlighted by the dashed-line connections shown in FIG. 1. Each retailer may also include a plurality of retailer outlets 108 at which the discount instruments may be presented by customers when goods and/or services are purchased by the customers at the retailer outlets 108. Operation of the retailer outlets 108 is also coordinated by the retailer center 112 for the respective retailers 104.

In embodiments of the invention, information regarding discount certificates that are presented at a retailer outlet 108 is collected electronically, as described below. This electronic information is aggregated for transmission to the central host 100 where reconciliation and other processing functions are carried out. FIG. 1 illustrates an embodiment in which the aggregation functions are performed by transaction aggregators 116 associated with each of the retailers 104. In such an embodiment, the electronic records regarding transactions using the discount certificates are transmitted from each of the retailer outlets 108 to the respective transaction aggregator 116, where they are aggregated. Multiple transaction aggregators 116 that are part of the infrastructure shown in FIG. 1 may then transmit the aggregated information to the central host 100. In an alternative embodiment, transaction aggregators 116 may be provided without association with a particular retailer, reflecting such considerations as geographic regions. In still other embodiments, use of the transaction aggregators 116 may be avoided, with transaction information being provided directly from the retailer outlets 108 to the central host 100.

In addition to the connection with the retailers 104 through the transaction aggregator 116, the central host 100 may also be provided with connections that permit direct interaction with the retailer centers 112, issuers 120, and financial institutions 124. Such connections may be provided with dedicated communication lines or, more usually, may be provided with network communications protocols, such as over the Internet or other network. In cases where shared network protocols are used, various encryption schemes known to those of skill in the art may be used to protect the transmission of sensitive information. The capability for such direct interaction may be used to provide funds-transfer instructions to the financial institutions 124 to effect settlement of transactions made with the discount certificates. This capability may also be used to provide reports to each of the retailers 104, issuers 120, and/or financial institutions 124 regarding settlement, fraud detection, and other aspects of reconciliation discussed below.

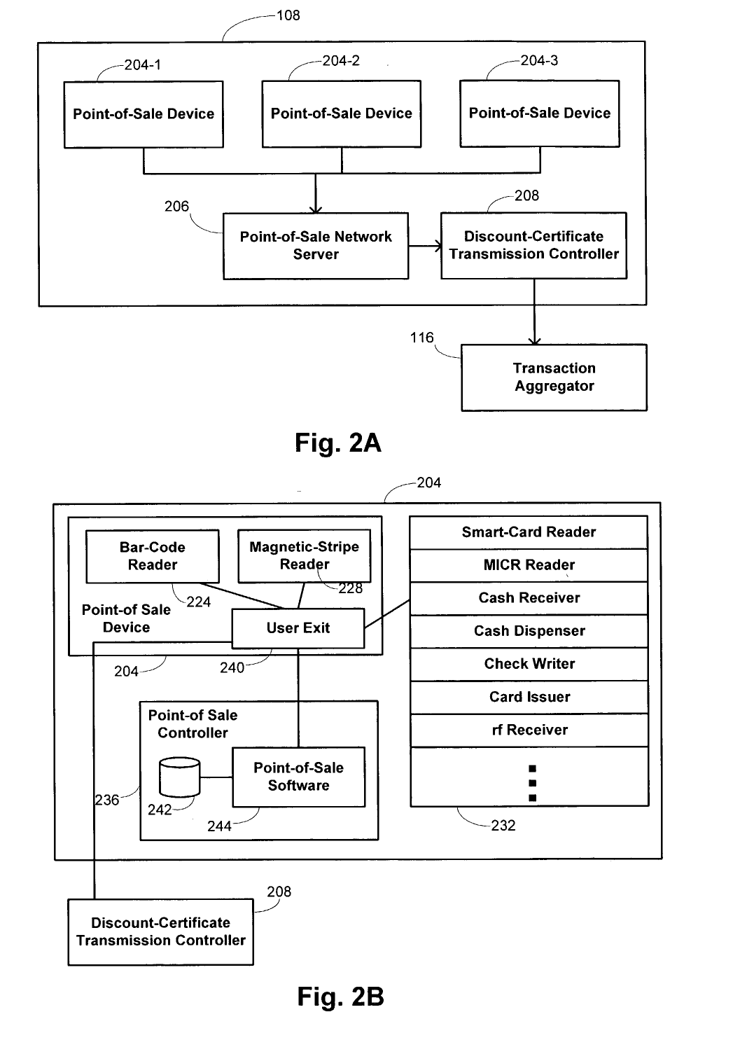

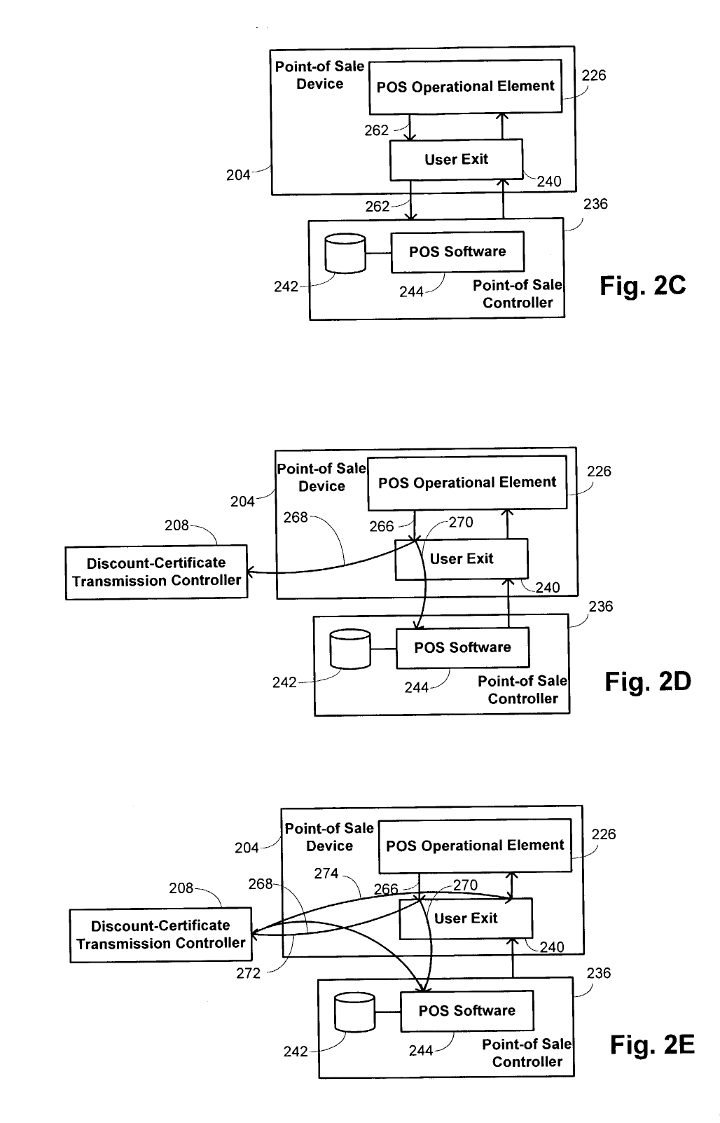

The manner in which information regarding the discount certificates may be collected is illustrated in FIGS. 2A and 2B. FIG. 2A schematically shows a structure that may be used internally at each retailer outlet 108 to collect information and format it for electronic transmission. The retailer outlet 108 may include a plurality of point-of-sale devices 204 distributed in the retailer outlet 108 for customer convenience. For example, the plurality of point-of-sale devices may be positioned at each of multiple checkout locations with a given store. Within the retailer outlet 108, operation of each of the point-of-sale devices 204 may be coordinated with a point-of-sale network server 206, which is configured for communication with a discount-certificate transmission controller 208. The transmission controller 208 may be configured as a device dedicated to receiving data from the point-of-sale network server 206 and aggregating it for further transmission. In an alternative embodiment, the functions of the point-of-sale network server 206 and transmission controller 208 may be combined in the form of a multifunctional device. In one embodiment, the transmission controller 208 may include the following hardware and software or its equivalent: a PowerPC 855 processor, 32 Mbyte of random-access memory (“RAM”), and a 4 Gbyte hard drive, using the Linux operating system and running an application written in the C programming language to perform the aggregation functions. In FIG. 2A, the transmission controller 208 is shown in communication with the transaction aggregator 116, which may similarly receive information transmitted from other retailer outlets 108. In alternative embodiments corresponding to different infrastructure arrangements discussed in connection with FIG. 1, the transmission controller 208 may instead be configured for communication directly with the central host 100 or with the corresponding retailer center 112.

The information to be communicated to the transmission controller 208 may be collected with a point-of-sale device 204 having the structural arrangement shown schematically in FIG. 2B. The specific configuration of the point-of-sale device may depend, in part, on the expected form of the discount instruments and how they are to be used at particular retailer outlets 108; this may depend on the nature of any business in which the retailer outlet 108 is engaged and the types of goods and/or services sold by the retailer outlet 108. The overall structure shown in FIG. 2B emphasizes those components that are sufficient for a retailer outlet 204 that relies on bar-code and magnetic-stripe encoding. For example, such a retailer outlet 204 may rely on bar codes to identify products in accordance with standardized classification systems, including, for example, the Universal Product Code (“UPC”) system, the European Article Number (“EAN”) system, the Global Trade Item Number (“GTIN”) system, the Serialized Shipping Container Code (“SSCC”) system, the Global Location Number (“GLN”) system, the Global Returnable Asset Identifier (“GRAI”) system, the Global Individual Asset Identifier (“GIAI”) system, and the Global Service Relation Number (“GSRN”) system, among others. Many of these systems are currently administered by the Uniform Code Council, Inc. (“UCC”) and EAN International. Paper discount certificates presented by customers seeking discounts may also include printed barcode information to identify the certificates and their content.

Magnetic-stripe information may be used to identify customers according to issued customer-identification cards and to process credit- and debit-card transactions. There are a variety of different types of customer-identification cards that may be used. In some embodiments, the card specifically issued by the retailer 104 to permit the customer to take advantage of special promotional discounts offered only to enrolled cardholders. The customer may be asked to provide demographic information, such as age, sex, and income level during enrollment. The use of the card benefits the customer by allowing him to obtain discounts that would otherwise not be available and benefits the retailer 104 by providing marketing information relating the purchase of certain products to certain customers. In other embodiments, a different customer-identification card may be used, such as a driver's license or other identifying instrument whose information has previously been obtained by the retailer 104.

The use of bar-code and magnetic-stripe encoding in this way is sufficient for a variety of types of retailer outlets 108 that sell virtually any type of goods and/or services, including supermarkets, hardware stores, department stores, movie cinemas, coffee shops, and the like. When the items being sold are goods, a bar code may be printed on a tag or label affixed to the goods; when the products being sold are services, a bar code may be printed on a ticket that entitles the customer to the service. Thus, FIG. 2B shows that the point-of-sale device 204 may comprise a bar-code reader 224 configured for reading bar-code information from such product labels or service tickets. In addition, the point-of-sale device 204 may include a magnetic-stripe reader for extracting magnetically encoded information from a customer-identification, debit, credit, or similar card.

In addition to their use in transactions, the bar-code reader 224 and/or magnetic-stripe reader 228 may also be used to collect identification information from the clerk operating the point-of-sale device 204. This may be done, for example, by providing each of the clerks in the retailer outlet 108 with encoded cards that must be scanned at the point-of-sale device 204 before it will operate. This capability permits every transaction executed with the point-of-sale device 204 to be associated with a particular responsible clerk. Such an association may be used as part of the fraud-detection techniques described below.

FIG. 2B explicitly notes that the point-of-sale device 204 may have additional or alternative components that may accommodate alternative mechanisms for obtaining information relevant to a transaction or to provide alternative mechanisms for executing the transaction. For example, while the current emphasis of the UCC and EAN International (i.e. the standards organizations identified above) is currently on bar-code technologies, including Reduced Space Symbology (“RSS”) and Composite Symbology (“CS”), they both acknowledge that the systems may alternatively be implemented using other technologies, such as with radio-frequency tags. Block 232 thus generically denotes alternative and supplementary components that may be used by the point-of-sale device. Such alternative and supplementary components include a smart-card reader for extracting information from a chip card; a magnetic-ink (“MICR”) reader for reading information printed with magnetic ink, such as on a check; a cash receiver for receiving cash payments; a cash dispenser for dispensing cash; a check writer for printing checks; a card issuer for issuing cards that may or may not include information encoded on a magnetic stripe; an rf receiver for receiving rf signals; and the like. Examples of point-of-sale devices that include multiple capabilities for identifying transaction instruments are provided in the following commonly assigned applications, the entire disclosures of which are incorporated herein by reference for all purposes: U.S. Prov. Pat. Appl. No. 60/147,889, entitled “INTEGRATED POINT OF SALE DEVICE,” filed Aug. 9, 1999 by Randy J. Templeton et al.; U.S. patent application Ser. No. 09/634,901, entitled “POINT OF SALE PAYMENT SYSTEM,” filed Aug. 9, 2000 by Randy J. Templeton et al.; U.S. patent application Ser. No. 10/116,689, entitled “SYSTEMS AND METHODS FOR PERFORMING TRANSACTIONS AT A POINT-OF-SALE,” filed Apr. 3, 2002 by Earney Stoutenburg et al.; U.S. patent application Ser. No. 10/116,733, entitled “SYSTEMS AND METHODS FOR DEPLOYING A POINT-OF-SALE SYSTEM,” filed Apr. 3, 2002 by Earney Stoutenburg et al.; U.S. patent application Ser. No. 10/116,686, entitled “SYSTEMS AND METHODS FOR UTILIZING A POINT-OF-SALE SYSTEM,” filed Apr. 3, 2002 by Earney Stoutenburg et al.; and U.S. patent application Ser. No. 10/116,735, entitled “SYSTEMS AND METHODS FOR CONFIGURING A POINT-OF-SALE SYSTEM,” filed Apr. 3, 2002 by Earney Stoutenburg. It should be appreciated that certain embodiments of the invention are not limited by the way in which information is collected and that still other ways of collecting information by a point-of-sale device may alternatively be used.

Operation of the various components of the point-of-sale device 204 may be coordinated by a point-of-sale controller 236. As shown in FIG. 2B, the point-of-sale device 204 may additionally comprise a user exit module 240 that permits information to be routed to the discount-certificate transmission controller 208. The point-of-sale controller 236 may comprise point-of-sale software 244 that controls the flow of information among the different components. The point-of-sale software may deposit or access data in data store 242 in processing the transaction, including accumulating records used in calculating the total amount of the transaction, applicable taxes, application of discounts, and the like, as well as retrieving product and/or customer information. An illustration is provided in FIGS. 2C-2E of how different information flows may be used in different embodiments. In each of these three figures, the information flow is shown with respect to a point-of-sale operational element 226, which may comprise the bar-code reader 224, the magnetic-stripe reader 228, or any of the alternative/supplementary components 232. In particular, a comparison of FIGS. 2D and 2E with FIG. 2C illustrates one method by which existing equipment may be used in an upgrade to provide discount-certificate processing in accordance with embodiments of the invention.

Thus, in FIG. 2C, the basic operation of the point-of-sale device 204 is illustrated by showing the flow of information in the absence of applying a discount certificate. Message 262 from the operational element 226 includes the information extracted by that operational element 226, such as decoded from a bar code or magnetic stripe. Since no discount-certificate information is included, message 262 is passed onto the point-of-sale software 244 by the user exit 240. The point-of-sale software 244 then acts on the message 262 to process the received transaction information. Such processing may comprise returning instructions to the same or a different operational element 226. For example, if the operational element 226 corresponds to the bar-code reader and the message 262 identifies a product being purchased, the point-of-sale software 244 may use the decoded product identifier to extract the price from the data store 242 and accumulate the running total of the purchase price. If the clerk indicates that payment is to be received, the point-of-sale software 244 may send a return instruction to the magnetic-stripe reader to read information from the customer's debit card.

The structure of FIG. 2C may be incorporated into systems that handle discount-certificate processing by adding a discount-certificate transmission controller 208 as shown in FIGS. 2D and 2E. Thus, in FIG. 2D, the message 266 received from the operational element 226 may include discounting information. Different portions of this information may be directed to the discount-certificate transmission controller 208 and to the point-of-sale software 244 by the user exit 240. For example, if the operational element 226 corresponds to the bar-code reader 224, and the decoded information identifies a discount certificate for a product that has already been identified, a first message 268 is transmitted to the transmission controller 208 that the discount is being applied and a second message 270 is transmitted to the point-of-sale software so that the proper discount may be applied to the transaction. The point-of-sale software 244 may return instructions to the same or a different operational element depending on the nature of the received message and as described above.

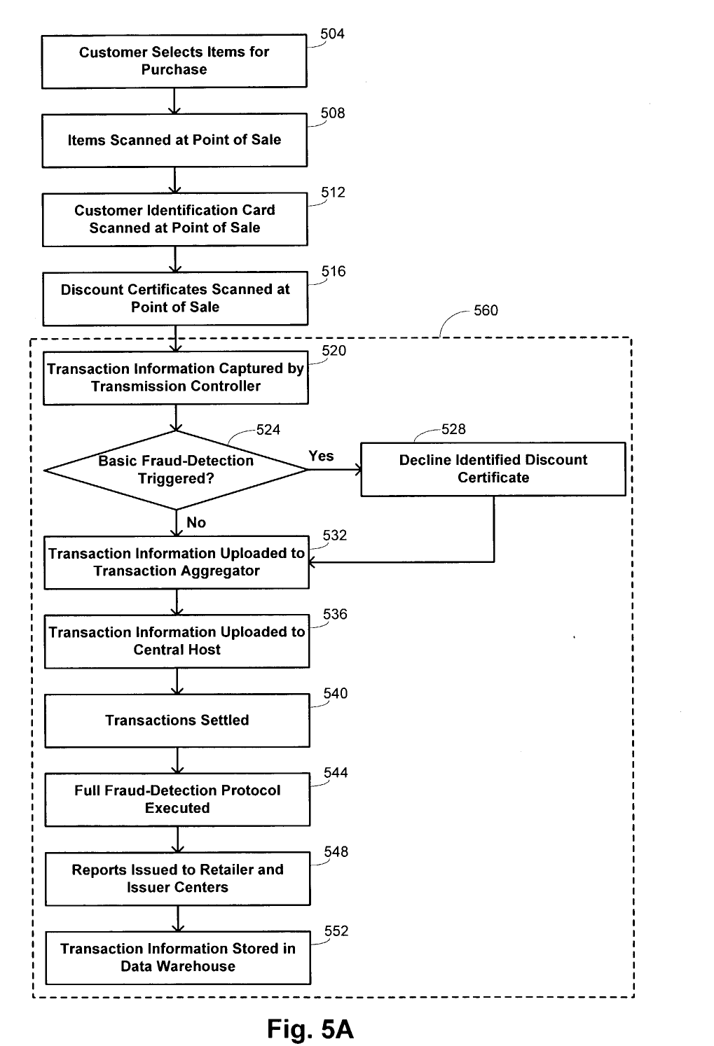

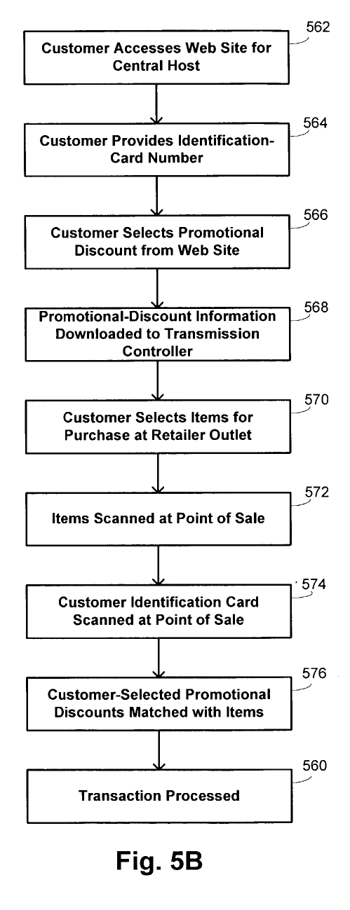

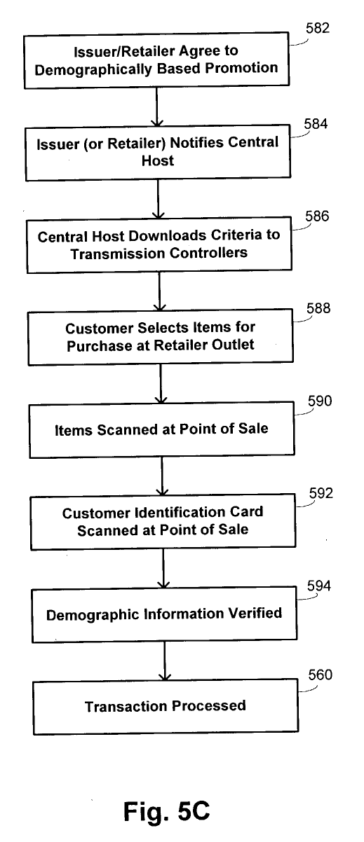

FIG. 2E illustrates that information may also be returned from the transmission controller 208 to one or both of the point-of-sale software 244 and user exit 240. This may be performed, for example, where the transmission controller 208 is configured for validation of the discount certificate. Thus, as in FIG. 2D, different portions of the message 266 received from the operational element 226 may be directed to the transmission controller 208 and to the point-of-sale software 244. If the discount certificate is validated by the transmission controller 208, a validation message 272 may be transmitted from the transmission controller 208 to the point-of-sale software 244. If the discount certificate is found to be invalid by the transmission controller, a nonvalidation message 274 may be transmitted to the user exit 240, which may act upon it by causing an error tone to sound or providing another error indication. Such validation by the transmission controller 208 is discussed in more detail below in the context of basic fraud detection (see FIG. 5A).

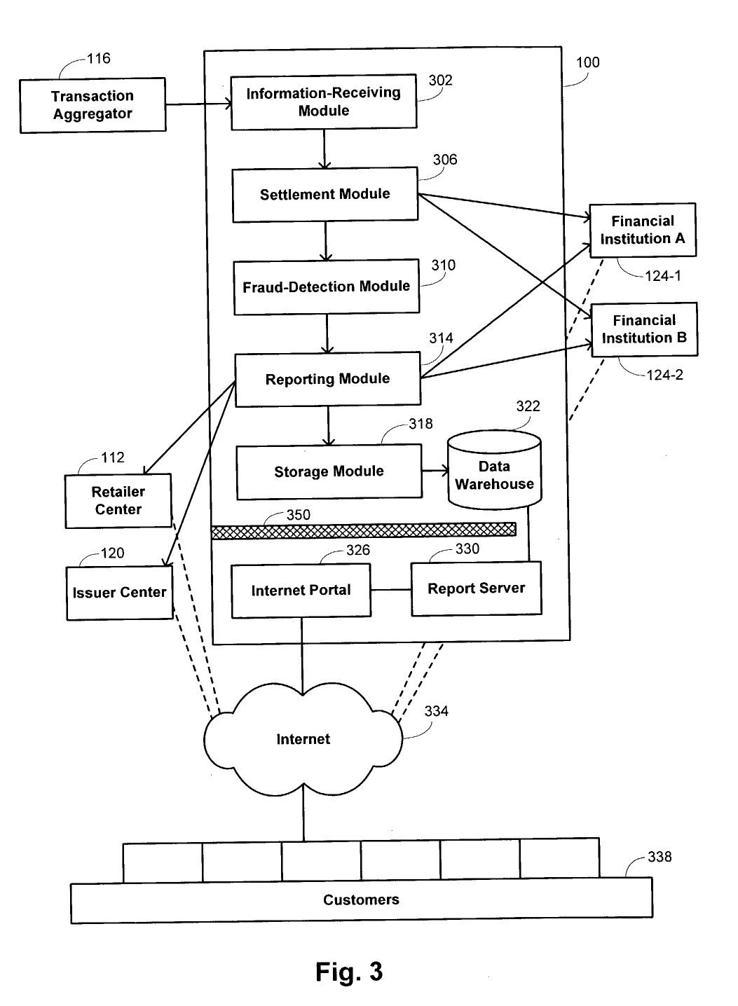

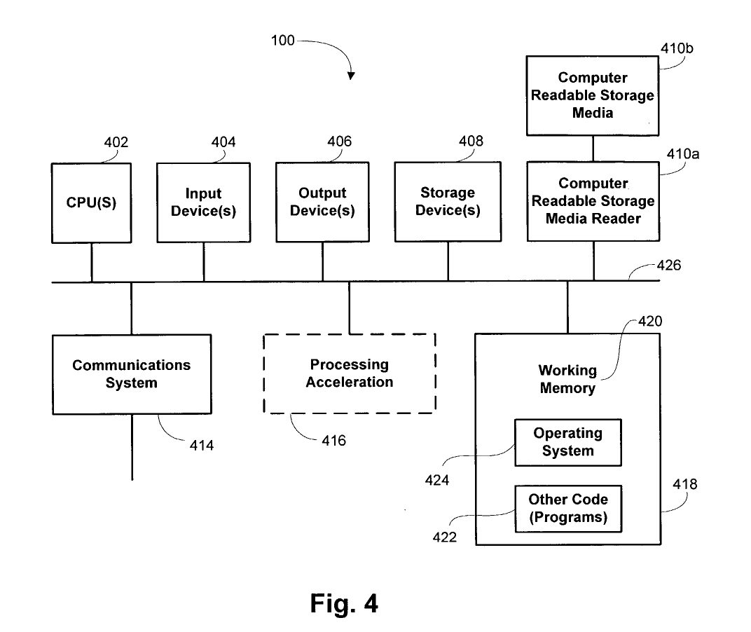

FIGS. 3 and 4 both show a structure for the central host 100, with FIG. 3 showing such a structure in terms of logical modules of the central host 100 and FIG. 4 showing physical components that may be used in the implementation of such logical modules. The following discussion makes reference first to the logical-module structure provided in FIG. 3. Information relating to transactions that involve the discount certificates may be received from the transaction aggregator 116 by an information-receiving module 302. The specific content of such information may vary in different embodiments depending on specific ways in which it is to be used, but may be broadly inclusive. Merely by way of example, the structure of the point-of-sale device 108 shown in FIGS. 2A and 2B permits one or more of the following pieces of information to be collected for each transaction: an identification of the customer; an identification of the product or service purchased; a UPC, EAN, or similar code for the product or service purchased; a quantity of the product or service purchased; the cost of the product or service purchased; the amount and conditions of any discount provided; an identification of the issuer of a discount certificate used; the method of payment for the product or service; an identification of an account from which funds were taken to pay for the product or service; an identification of the clerk; an identification of the specific retailer outlet and device at which the transaction took place; an identification of the date and time of the transaction; and the like. This information is received by the information-receiving module after being routed through the communications infrastructure shown in FIG. 1.

The information-receiving module 302 is adapted to route relevant portions of the information to each of a plurality of other modules, each adapted to perform a portion of the processing. The modules may be accessed sequentially, as illustrated in FIG. 3, or may be accessed in parallel by receiving relevant portions of the information substantially simultaneously from the information-receiving module 302.

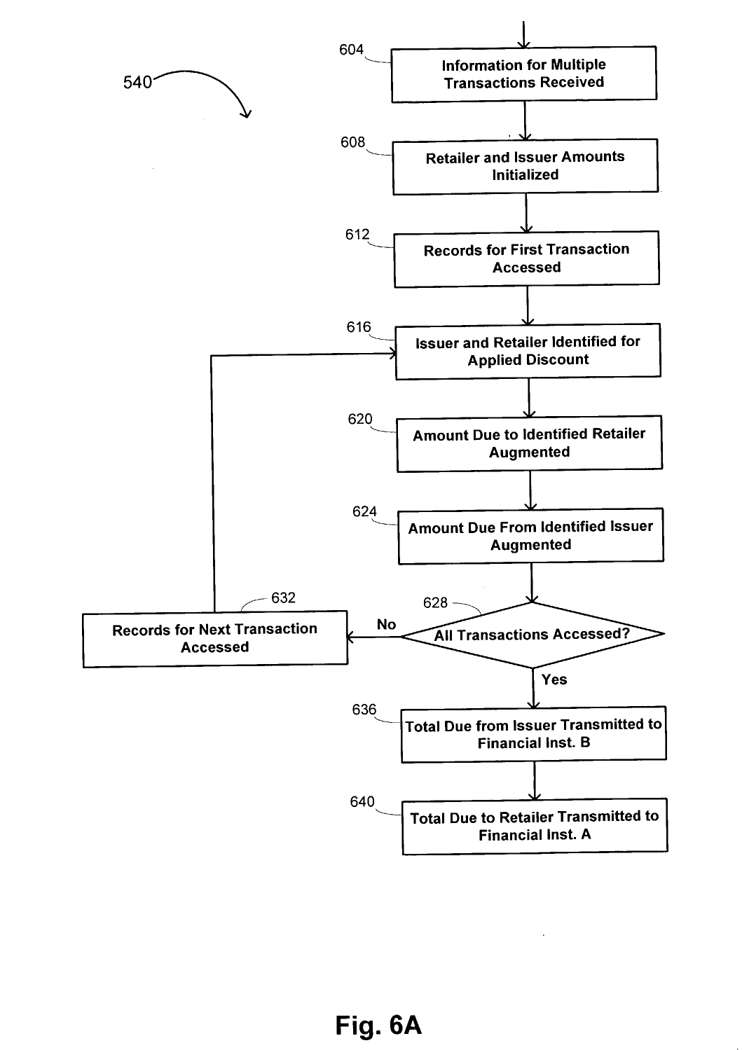

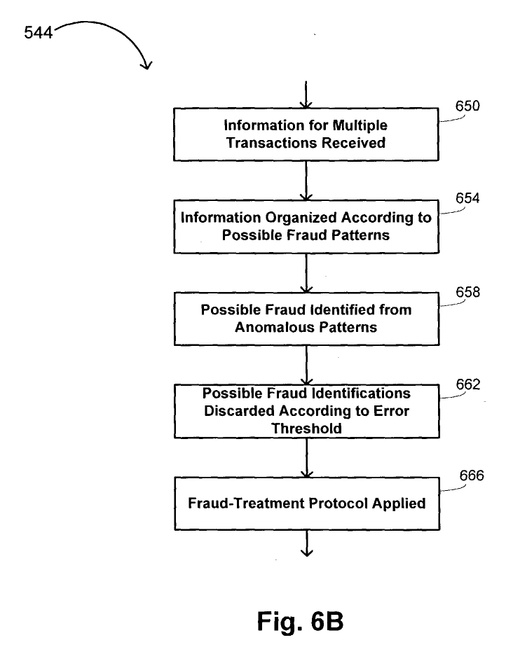

For example, a settlement module 306 is adapted to settle discounts that have been provided by the retailer on behalf of the issuer. Accordingly, the settlement module is configured to provide communications to financial institution A 124-1, which may hold the retailer's financial account, and to financial institution B 124-2, which may hold the issuer's financial account. Settlement is effected by instructing the respective financial institutions to debit or credit suitable amounts to accommodate the discounts. An example of how the amounts may be calculated in an embodiment is described in greater detail below in connection with FIG. 6A.

A fraud-detection module 310 may be used to analyze the transactions for patterns that indicate the possibility of fraudulent activity, particularly in connection with use of the discount certificates. Further description of techniques that may be used by the fraud-detection module 310 is provided below in connection with FIG. 6B.

A reporting module 314 may be adapted to provide information back to any or all of the parties that may be involved with or affected by the transactions. Accordingly, the reporting module 314 may be configured to provide communications to each of the financial institutions 124, to the retailer centers 112, and to the issuer centers 120. The reporting module may be configured to provide a variety of different types of reports depending on the preferences of individual retailers 104, issuers 120, and/or financial institutions 124. For example, a report could include only summary information specifying the number of transactions, their total cost, and the total discounts applied from each issuer. Alternatively, a report could include detailed transaction information specifying the particulars of every transaction. In other instances, the report could have an intermediate amount of information organized as specified by the party to receive the report. Most generally, the report may include or be drawn from any of the pieces of information received by the information-receiving module 302.

A storage module 318 may be adapted to store the transaction information in a data warehouse 322. The transaction information may be stored in the form in which it is received from the information-receiving module 302 or may be placed into an alternative format prior to storage. In part because of the very large volume of information that may be stored, the usefulness of the data warehouse will be enhanced when the information is stored in a format that permits easy retrieval according to various search queries. Access to some or all of the information in the data warehouse 322 may be provided to any or all of financial institutions 124, retailers 104, issuers 120, and/or customers 338. Such access may be provided by using a network such as the internet 334 to provide a connection to a report server 330 through an internet portal 326. The modules of the central host 100 and the data warehouse itself may be isolated from the internet 334 with a firewall 350 to prevent unauthorized access to the information.

Usually, the report server 330 is configured to limit retrieval of information from the data warehouse to information that is relevant to the party requesting it. For example, a retailer 104 will normally be permitted only to retrieve information regarding transactions performed at its retailer outlets 108 and will be restricted from accessing information relating to transactions performed at outlets of another retailer. The internet portal 326 permits a query interface to be provided to the party requesting retrieval of information. Such a query interface thus permits retrieval to be restricted according to parameter limitations placed on any of the different types of information. Merely by way of example, an issuer could thus request retrieval of the locations at which all of its discount certificates for Product X were used, thereby providing valuable marketing information. In cases where the customers have provided demographic information in order to receive their identification cards, similar queries may be used to provide valuable correlations between marketing and demographic parameters. In some embodiments, the value of such information may be reflected by charging a fee for submitting queries to the data warehouse 322.

FIG. 4 provides a schematic illustration of a hardware structure that may be used to implement the central host 100. FIG. 4 broadly illustrates how individual system elements may be implemented in a separated or more integrated manner. The central host 200 is shown comprised of hardware elements that are electrically coupled via bus 426, including a processor 402, an input device 404, an output device 406, a storage device 408, a computer-readable storage media reader 410a, a communications system 414, a processing acceleration unit 416 such as a DSP or special-purpose processor, and a memory 418. The computer-readable storage media reader 410a is further connected to a computer-readable storage medium 410b, the combination comprehensively representing remote, local, fixed, and/or removable storage devices plus storage media for temporarily and/or more permanently containing computer-readable information. The communications system 414 may comprise a wired, wireless, modem, and/or other type of interfacing connection and permits data to be exchanged with the transaction aggregator 116, retailers 104, issuers 120, financial institutions 124, and Internet 334 to implement embodiments as described above.

The central host 200 also comprises software elements, shown as being currently located within working memory 420, including an operating system 424 and other code 422, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

The correspondence between the functional illustration of the central host 100 in FIG. 3 and the hardware illustration in FIG. 4 may be understood as follows. The data warehouse 322, as well as any data that may be accessed in order to implement the functional operations, is stored in the storage devices 408. Software to define the operation of the data information-receiving module 302, settlement module 306, fraud-detection module 310, reporting module 314, and storage module 318 is included in the memory 418 and implemented by the processors 402. A structure similar to that of FIG. 4 may also be used for the transmission controller 208 and/transmission aggregator 116.

Methods that use the structures described in connection with FIGS. 1-4 to implement embodiments of the invention are illustrated with flow diagrams in FIGS. 5A-6B. The flow diagram of FIG. 5A provides an overview of one embodiment in which a customer makes a purchase using a discount instrument. At block 504, the customer selects items, which may include products or services, for purchase, such as at a retailer outlet 108. The items are scanned with the point-of-sale device 204, such as by using the bar-code reader 224 described above. This permits the point-of-sale device to identify the product, including its size, weight, and/or volume, as well as cost. In addition, the point-of-sale device 204 may determine the number of items being purchased, a factor that may be relevant for discount instruments that require the purchase of a specific number of identified items. This information may be used both to apply the appropriate cost to the transaction and to update inventory files that may be maintained by the retailer outlet 108.

At block 512, the customer identification card is optionally scanned, such as by using the bar-code reader 224 or magnetic-stripe reader 228 described above. While scanning of the customer identification card is desirable in many embodiments, it is not required in others. Such scanning permits the point-of-sale device 204 to retrieve a record of the customer's identity, and perhaps also demographic information about the customer that may have been provided when the customer enrolled. In some instances, the identification of the customer provided from the customer-identification card may be used in the administration of a loyalty program, providing benefits to the customer. Examples of such loyalty programs are described in detail in copending, commonly assigned U.S. patent application Ser. No. 10/079,927, entitled “SYSTEMS AND METHODS FOR OPERATING LOYALTY PROGRAMS,” filed Feb. 19, 2002 by Colleen George and John Cawthorne, the entire disclosure of which is incorporated herein by reference for all purposes.

Any discount instruments that may be presented by the customer are scanned or retrieved electronically at block 516 with the point-of-sale device 204, such as by using the bar-code reader 224. This permits the point-of-sale device 204 to determine the amount of discount to be applied as well as any conditions that may be required by the discount certificate, such as that it be applied only to specific items and be applied before a specified expiration date. Under circumstances where the discount certificate comprises a physical discount certificate that is not easy to scan, such as where it comprises a printed bottle cap or other difficult-to-scan form, a clerk may key information from the discount certificate into the point-of-sale device 204 manually.

At block 520, the transaction information obtained from scanning the items, the customer-identification card, and the discount certificates at blocks 508, 512, and 516 is captured from the point-of-sale device 204 by the transmission controller 208. In addition, information inherent to the point-of-sale device 204, such as an identifier of the particular point-of-sale device 204 and the current date and time, are also captured. In some embodiments, the transmission controller 208 may be configured to perform a minimal level of fraud detection, referred to as “basic fraud detection,” at block 524. Such basic fraud detection comprises verifying to the extent possible with the information available to the transmission controller 208 that the conditions of each of the scanned discount certificates have been met. For example, in one embodiment, the transmission controller 208 compares the current date with the expiration date of the discount certificate. If the current date is later than the expiration date, the discount certificate may be declined at block 528. Similarly, in another embodiment, the transmission controller 208 compares the item specifications determined when scanning the item, such as its size, weight, volume, and/or the quantity of items purchased with the specifications set forth in conditions of the discount certificate. If the item specifications differ from the specified conditions, the discount certificate is declined at block 528.

Generally, the scanning of items, customer-identification card, and discount certificates at blocks 508, 512, and 516 may be performed in any order. In embodiments where a check is made at block 524 for basic fraud detection, however, it may be desirable to perform the scanning of discount certificates 516 after scanning items 508. In such instances, the interaction between the transmission controller 208 and the point-of-sale device 204 may take place as described in connection with FIG. 2E, with an audible or visible alarm being initiated from the perspective of the customer and clerk substantially simultaneously with scanning of the declined discount certificate. In other instances, such as where the discount certificates are scanned prior to scanning the items, the declined discount certificates may be identified as a group when the transaction is completed. In embodiments where no basic fraud detection is implemented, the interaction between the transmission controller 208 and the point-of-sale device 204 may instead take place as described in connection with FIG. 2D.

The basic fraud detection implemented at block 524 may be configured to tolerate small deviations as part of a customer-service enhancement program. For example, a discount instrument may be accepted provided no more than a month has passed from the expiration date, or may be accepted if the size of the item it offers a discount for differs from what is specified but otherwise matches in all respects. In some cases, the issuer may honor the discount instrument despite such small deviations. In other cases, the issuer may refuse to honor the discount instrument, in which case the cost of the discount may be borne by the retailer 104 instead of by the issuer 120. For example, in cases where the discount instrument requires that a particular number of the items be purchased, it may be accepted even if a predetermined fewer number are purchased. Suppose a discount instrument requires the purchase of four of the items. It is possible in such a case for the discount to be applied if only three items are purchased, but for the discount to be declined if fewer than three items are purchased. Furthermore, the system permits the collection of statistical information regarding the numbers of items actually being purchased by customers, which can be provided back to issuers for informational purposes.

After capturing the transaction information with the transmission controller 208, and perhaps also performing basic fraud detection at the level described, the transaction information is uploaded to the transaction aggregator 116 at block 532. The transaction aggregator 116 may generally receive transaction information originating from a variety of retailer outlets 108 for a particular retailer 104. This transaction information may be formatted and/or organized for uploading to the central host 100 at block 536. After receipt of the transaction information by the central host 100, the different logical modules may be applied to process the transaction information, with the transactions being settled at block 540, the fraud-detection protocol being executed at block 544, reports being issued to the retailer and issuer centers 112 and 120 at block 548, and the transaction information being stored in the data warehouse 322 at block 552.

The combination of blocks 520-552 is denoted generically in FIG. 5A as block 560 and corresponds to transaction processing that is common to a number of embodiments. Examples of alternative embodiments that also use the transaction processing 560 are provided with the flow diagrams in FIGS. 5B and 5C. Such alternative embodiments provide examples of different types of discount certificates that may be accommodated with the structure described in connection with FIGS. 1-4. Still other types of discount certificates that may be accommodated with be evident to those of skill in the art after reading this disclosure.

FIG. 5B provides an example where a discount certificate is generated as an electronic discount certificate by a customer in accordance with certain established promotional parameters. At block 562, the customer accesses an Internet web site for the central host 100, such as by establishing a connection with Internet portal 326. The Internet web site may include various promotional items that the customer may register for, with the infrastructure described above being used to apply the registered promotion for the customer automatically. Thus, at block 564, the customer provides a reference to his customer-identification card, such as by entering the number of the identification card.

At block 566, the customer selects the promotional discounts that he desires from the presentation on the web site. For example, the web site may include a list of promotional discounts being offered by different issuers 120 and/or at different retailers 104. This list may be organized according to the identity of the issuer 120, the identity of the retailer 104, the type of item that is the subject of the promotional discount, the value of the discount, and the like. Conditions for the application of the promotional discounts may be specified. The customer may make his selection by checking off check boxes beside each of the desired discounts, or by using any other equivalent or alternative selection mechanisms. This electronically based mechanism for selection of discount certificates may, in some instances, be viewed as an alternative to coupon clipping. This alternative provides significant convenience to the customer by providing a larger number of available discount certificates in a single place rather than needing to wait for promotional flyers or having to purchase newspapers or magazines to gain access to the discount certificates. In addition, the web-site interface may provide convenient organizational tools that simplifying identifying desired discount certificates by the customer. This alternative also benefits the issuers 120 and/or retailers 104 by reducing printing and distribution costs for their discount certificates.

After the customer has made his selections, the promotional discount information is downloaded to one or more transmission controllers 208 as appropriate. The downloaded information thus corresponds to electronic discount certificates that may be used to implement the choices made by the customer. The downloading may be accomplished by using the communications connections shown in FIGS. 1-4, effectively using the reverse pathways previously described for uploading information to the central host 100 from the transmission controllers 208. In some embodiments, the relevant information may be downloaded to all the transmission controllers 208, but in other instances such downloading may be done selectively based on the selections made by the customer. In one embodiment, the customer may additionally be asked at block 566 to identify the retailer outlet 108 where he will be making associated purchases, with the downloading being performed only to the respective transmission controller 208.

The discounts may subsequently be applied automatically without the need for the customer to present paper discount certificates. Thus, at block 570, the customer selects items for purchase and they are scanned using the point-of-sale device 204 at block 572. Scanning of the customer identification card at block 574 permits the transmission controller 208 to match the items being purchased with the downloaded records of electronic discount certificates. Accordingly, the discounts may then be applied to the transaction using the transaction processing 560 methods discussed in connection with FIG. 5A.

FIG. 5C provides an example where discount certificates may be applied to transactions involving a customer with no overt action on the part of the customer to receive the discount. In the example, the discount certificates are based on qualifying demographic criteria of customers. For example, an issuer may wish to induce a particular demographic segment to try certain products, such as where market penetration of the product for that demographic segment is small. Accordingly, at block 582, the issuer 120 and retailer 104 reach an agreement on a demographically based promotion. One such agreement, merely by way of example, may be that women between the ages of 45 and 64 who purchase product X (which is currently enjoying sales primarily among women between the ages of 25 and 34) at one of the retailer's outlets 108 are entitled to a 30% reduction in its cost. This fact may be advertised on television, on radio stations, in print, and the like. One or both of the issuer 120 and retailer 104 notifies the central host 100 of the criteria for implementing the program so that the central host 100 may download the criteria to affected transmission controllers 208. The downloaded criteria thus correspond to discount certificates that implement the program.

From the perspective of the customer, all that is required to take advantage of the program is to present a customer-identification card when the item is purchased. Thus, at block 588, the customer selects items for purchase at one of the participating retailer outlets 108. The items and customer identification card are respectively scanned with the point-of-sale device 204 at blocks 590 and 592. Provided that the customer has provided demographic classification information that is linked with his customer-identification card, the demographic-based qualification for the discount may be verified at block 594. Accordingly, the transaction is processed at block 560, and the discount applied, using the methods discussed in connection with FIG. 5A.

The various examples of the application of discount certificates discussed in connection with FIGS. 5A-5C are not exclusive. For example, a single customer may make use of all three types in a single transaction, and perhaps also other techniques that use other types of discount certificates. Merely by way of example, the customer may select several items when shopping at a supermarket, including (1) a box of cookies for which he has clipped a paper coupon; (2) a tube of toothpaste for which he registered a discount using the Internet service; and (3) a can of shaving lotion that he saw advertised on television as providing a discount to people in his demographic group. When all of his items are rung up at the point-of-sale device, his cookie coupon will be scanned, his registered toothpaste discount will be identified from the electronic discount certificate downloaded to the transmission controller, and his demographic qualification will be recognized as another electronic discount certificate downloaded to the transmission controller. Accordingly, the central host will apply all three of the discounts according to the transaction processing 560 discussed above, with the total amount due being reduced by each of the value of his cookie coupon, the value of his registered toothpaste discount, and the value of the demographic promotion.

FIG. 6A provides a detailed flow diagram illustrating an embodiment for performing the settlement of transactions at block 540. The method begins by receiving information for multiple transactions at block 604. This information may define transactions executed between different customers and retailers, and may include information regarding discounts to be paid by different issuers. In some instances, some preprocessing may have been performed by the transaction aggregator 116 to organize the information more conveniently, such as by grouping all transactions having discounts for a common issuer, but this is not necessary. At block 608, retailer and issuer amounts ultimately to be credited to or debited from the respective parties are initialized. Records for a first of the transactions are accessed at block 612, and the issuer and retailer involved in any applied discount are identified at block 616.

At block 620, the amount due to the identified retailer is augmented. Usually this amount is greater than the discount that was applied to reflect a handling fee due to the retailer. At block 624, the amount due from the identified issuer is also augmented. Usually this amount is greater still than the amount due to the retailer, reflecting an additional handling fee due to the administrator of the central host 100. The method steps through each of the transactions by making a check a block 628 whether all transactions have been accessed and moving to the next transaction records at block 632 if they have not. Once all the transactions have been considered, the respective financial institutions 124 are notified by the central host 100 to transfer funds in accordance with the settlement. Thus, at block 636, the total due from the issuer is transmitted to financial institution B 124-2 and, at block 640, the total due to the retailer is transmitted to financial institution A 124-1.

FIG. 6B provides a detailed flow diagram illustrating an embodiment for performing fraud detection at block 544. The method begins by receiving information for multiple transactions at block 650. The information is organized according to possible fraud patterns at block 654. Such fraud patterns may result from such behavior as a clerk scanning a discount instrument when no corresponding items are purchased or from scanning a discount instrument multiple times when only a single corresponding item is purchased. The organized information is analyzed at block 658 to identify anomalous patterns that may indicate possible fraud. The central host 100 may be configured to recognize that some anomalous patterns may be the result of simple errors rather that the result of deliberate fraud. Accordingly, an error threshold measure may be applied to the possible fraud identifications at block 662 to eliminate consideration of anomalous patterns that are more likely to result from errors.

The pattern recognition and analysis functions performed in blocks 654, 658, and 662 may be aided by a variety of artificial-intelligence techniques. For example, in one embodiment, a neural net may be used to make perform the pattern recognition and analysis. A typical neural network includes a plurality of nodes, each of which has a weight value associated with it. The network includes an input layer having a plurality of input nodes and an output layer having a plurality of output nodes, with at least one layer therebetween. The output nodes generate probabilistic indications of fraud based on combinations of transaction data provided to the input nodes according to the arrangement of the intermediate nodes. In order to train the neural net, the output values are compared against the correct interpretation with some known samples. If the output value is incorrect when compared against such a test interpretation, the neural net modifies itself to arrive at the correct output value. This is achieved by connecting or disconnecting certain nodes and/or adjusting the weight values of the nodes during the training through a plurality of iterations. Once the training is completed, the resulting layer/node configuration and corresponding weights represents a trained neural net. The trained neural net is then ready to receive unknown transaction data and designate fraud probabilities. Classical neural nets include Kohonen nets, feed-forward nets, and back-propagation nets. The different neural nets have different methods of adjusting the weights and organizing the respective neural net during the training process. The fraud-detection methods may alternatively make use of any of a variety of other pattern-recognition techniques, including the use of expert systems, the use of genetic algorithms and the like.

If likely fraud is detected, a fraud-treatment protocol is applied at block 666. There are a number of different types of fraud-treatment protocols that are within the scope of the invention. In one embodiment, the transactions identified as likely being fraudulent are reversed. This may be accomplished by the central host 100 by issuing instructions to the financial institutions 124. The account of the retailer 104 is debited by the portion that corresponds to the discounts and handling fees previously applied and the account of the issuer 120 is credited by the portion that corresponds to the discounts and handling fees previously applied. In another embodiment, the amounts that correspond to the likely fraud are deposited into a separate escrow account. Funds from the escrow account are applied only once the fraud has been confirmed or discounted.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for processing a plurality of discounted transactions, the method comprising:
receiving at a host computer transaction information for each of the plurality of discounted transactions, the transaction information identifying a discount amount applied to a sale of an item by a retailer on behalf of an issuer of a corresponding discount;
determining an amount due from each issuer in accordance with the transaction information for the plurality of discounted transactions;
determining an amount due to each retailer in accordance with the transaction information for the plurality of discounted transactions; and
transmitting requests to one or more financial institutions to transfer funds in accordance with the determined amounts due from each issuer and to each retailer.

2. The method recited in claim 1 wherein the discount amount is defined by a discount certificate.

3. The method recited in claim 2 wherein the discount certificate comprises a coupon.

4. The method recited in claim 2 wherein the discount certificate comprises an electronic record of terms for application of the discount amount to purchase of the item.

5. The method recited in claim 1 wherein receiving transaction information comprises receiving transaction information for a plurality of the discounted transactions from a transaction aggregator in communication with a plurality of retailer outlets.

6. The method recited in claim 1 wherein receiving transaction information comprises receiving transaction information for a plurality of the discounted transactions directly from a plurality of retailer outlets.

7. The method recited in claim 1 further comprising analyzing the transaction information to identify potential fraud.

8. The method recited in claim 7 wherein analyzing the transaction information comprises ensuring that an expiration date of the corresponding discount is later than a date the discount amount is applied.

9. The method recited in claim 7 wherein analyzing the transaction information comprises ensuring that the item corresponds to an item specified by terms of the corresponding discount.

10. The method recited in claim 7 wherein analyzing the transaction information comprises applying an error tolerance filter.

11. The method recited in claim 7 further comprising depositing funds associated with the potential fraud into an escrow account.

12. The method recited in claim 7 further comprising transmitting requests to the one or more financial institutions to reverse the funds transfer with respect to funds associated with the potential fraud.

13. The method recited in claim 1 wherein the item comprises a product.

14. The method recited in claim 1 wherein the item comprises a service.

15. The method recited in claim 1 wherein terms of the corresponding discount specify qualifying demographic criteria for a purchaser of the item.

16. The method recited in claim 1 further comprising issuing reports to the retailer and issuer regarding the transfer of funds.

17. The method recited in claim 1 further comprising storing the transaction information in a queriable data store.

18. The method recited in claim 1 wherein determining the amount due from each issuer comprises adding a handling fee for each corresponding discounted transaction.

19. A method for processing plurality of discounted transactions, the method comprising:
receiving at a transmission controller transaction information for each of the plurality of discounted transactions, the transaction information identifying terms for application of a discount amount;
determining with the transmission controller whether the terms have been met; and
transmitting the transaction information to a host computer if the terms have been met.

20. The method recited in claim 19 wherein the discount amount is defined by a discount certificate.

21. The method recited in claim 20 wherein the discount certificate comprises a coupon.

22. The method recited in claim 20 wherein the discount certificate comprises an electronic record of terms for application to the discount amount to purchase of the item.

23. The method recited in claim 19 further comprising analyzing the transaction information to ensure compliance with the terms.

24. The method recited in claim 23 wherein analyzing the transaction information comprises ensuring that an expiration date specified by the terms is later than a date the discount amount is applied.

25. The method recited in claim 23 further wherein:
the transaction information further identifies items purchased; and
analyzing the transaction information comprises ensuring that at least one of the items purchased corresponds to an item specified by the terms.

26. The method recited in claim 23 wherein:
the transaction information further identifies demographic characteristics of a purchaser of the items; and
analyzing the transaction information comprises ensuring that the demographic characteristics of the purchaser are consistent with qualifying demographic criteria specified by the terms.

27. A method for providing an electronic discount instrument, the method comprising:
providing an electronic customer interface to present a plurality of possible discount-term selections, each such selection specifying at least an item and discount amount;
receiving a customer identifier for a customer through the interface;
receiving an identification of at least one selected discount-term selection from the customer through the interface; and
transmitting the customer identifier and the at least one selected discount-term selection to a transmission controller.

28. The method recited in claim 27 further comprising:
receiving transaction information for purchase of the item corresponding to the at least one selected discount-term selection by the customer from a point-of-sale device; and
transmitting instructions to the point-of-sale device to apply the discount amount to the purchase of the item corresponding to the at least one selected discount-term selection.

29. The method recited in claim 28 further comprising transmitting the transaction information to a host computer for settlement.

30. The method recited in claim 28 further comprising analyzing the transaction information to ensure compliance with terms of the at least one selected discount-term selection.

31. The method recited in claim 28 wherein the transmission controller and the point-of-sale device are located at the same retailer outlet.

32. A method for providing an automatic transaction discount, the method comprising:
receiving qualifying demographic criteria and an item identification for application of a discount amount;
receiving transaction information for purchase of the item from a point-of-sale device;
receiving customer identification information for the purchase of the item;
accessing demographic information for a customer with the customer identification information; and
transmitting instructions to the point-of-sale device to apply the discount amount if the demographic information for the customer is consistent with the qualifying demographic criteria.

33. The method recited in claim 32 further comprising transmitting the transaction information to a host computer for settlement.

34. A computer-readable storage medium having a computer-readable program embodied therein for directing operation of a host computer including a communications system, a processor, and a storage device, wherein the computer-readable program includes instructions for operating the host computer to process a plurality of discounted transactions in accordance with the following:
receiving with the communications system transaction information for each of the plurality of discounted transactions, the transaction information identifying a discount amount applied to a sale of an item by a retailer on behalf of an issuer of a corresponding discount;
determining with the processor an amount due from each issuer in accordance with the transaction information for the plurality of discounted transactions;
determining with the processor an amount due to each retailer in accordance with the transaction information for the plurality of discounted transactions; and
transmitting requests with the communications system to one or more financial institutions to transfer funds in accordance with the determined amounts due from each issuer and to each retailer.

35. The computer-readable storage medium recited in claim 34 wherein the discount amount is defined by a discount certificate.

36. The computer-readable storage medium recited in claim 35 wherein the discount certificate comprises a coupon.

37. The computer-readable storage medium recited in claim 35 wherein the discount certificate comprises an electronic record of terms for application of the discount amount to purchase of the item.

38. The computer-readable storage medium recited in claim 34 wherein the computer-readable program further includes instructions for analyzing the transaction information with the processor to identify potential fraud.

39. The computer-readable storage medium recited in claim 38 wherein analyzing the transaction information comprises applying an error tolerance filter.

40. The computer-readable storage medium recited in claim 38 wherein the computer-readable program further includes instructions for transmitting instructions with the communications system to the one or more financial institutions to deposit funds associated with the potential fraud into an escrow account.

41. The computer-readable storage medium recited in claim 38 wherein the computer-readable program further includes instructions for transmitting requests with the communications system to the one or more financial institutions to reverse the funds transfer with respect to funds associated with the potential fraud.

42. The computer-readable storage medium recited in claim 34 wherein terms of the corresponding discount specify qualifying demographic criteria for a purchaser of the item.

43. The computer-readable storage medium recited in claim 34 wherein the computer-readable program further includes instructions for issuing reports to the retailer and issuer regarding the transfer of funds.

44. The computer-readable storage medium recited in claim 34 wherein the computer-readable program further includes instructions for storing the transaction information in a queriable data store on the storage device.

45. A computer-readable storage medium having a computer-readable program embodied therein for directing operation of a transmission controller including a communications system, a processor, and a storage device, wherein the computer-readable program includes instructions for operating the transmission controller to process a plurality of discounted transactions in accordance with the following:
receiving with the communications system transaction information for each of the plurality of discounted transactions, the transaction information identifying terms for application of a discount amount;
determining with the processor whether the terms have been met; and
transmitting the transaction information with the communications system to a host computer if the terms have been met.

46. The computer-readable storage medium recited in claim 45 wherein the discount amount is defined by a discount coupon.

47. The computer-readable storage medium recited in claim 46 wherein the discount certificate comprises a coupon.

48. The computer-readable storage medium recited in claim 46 wherein the discount certificate comprises an electronic record of terms for application of the discount amount to purchase of the item.

49. The computer-readable storage medium recited in claim 45 wherein the computer-readable program further includes instructions for analyzing the transaction information with the processor to ensure compliance with the terms.

50. The computer-readable storage medium recited in claim 49 wherein analyzing the transaction information comprises ensuring that an expiration date specified by the terms is later than a date the discount amount is applied.

51. The computer-readable storage medium recited in claim 49 wherein:
the transaction information further identifies items purchased; and
analyzing the transaction information comprises ensuring that at least one of the items purchased corresponds to an item specified by the terms.

52. The computer-readable storage medium recited in claim 49 wherein:
the transaction information further identifies demographic characteristics of a purchaser of the items; and
analyzing the transaction information comprises ensuring that the demographic characteristics of the purchaser are consistent with qualifying demographic criteria specified by the terms.
